(19) United States
(12) Patent Application Publication
(10) Pub. No.: US 2008/0140488 A1
(43) Pub. Date: Jun. 12, 2008

(54) EVENT SCHEDULING CONFLICT MANAGEMENT AND RESOLUTION FOR UNPROCESSED EVENTS IN A COLLABORATIVE COMPUTING ENVIRONMENT

(76) Inventors: Tolga Oral, Winchester, MA (US); Sergei R. Landar, Cambridge, MA (US); Andrew L. Schirmer, Andover, MA (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(21) Appl. No.: 11/608,682

(22) Filed: Dec. 8, 2006

(51) Int. Cl. G06Q 10/00

(52) U.S. Cl. 705/8

(57) ABSTRACT

Embodiments of the present invention address deficiencies of the art in respect to meeting time conflict management and resolution in a C&S system and provide a method, system and computer program product for event scheduling conflict management and resolution for unprocessed events in a collaborative computing environment. In one embodiment of the invention, a method of event scheduling conflict management and resolution for unprocessed events can be provided for a collaborative computing environment. The method can include proposing a new calendar event for a specified time slot not already scheduled for a processed calendar event, identifying an unprocessed, unscheduled, proposed event conflicting with the specified time slot, and prompting for conflict resolution of the conflict.

### BACKGROUND OF THE INVENTION

1. Field of the Invention

The present invention relates to the field of collaborative computing and more particularly to event scheduling conflict management and resolution in a collaborative computing environment.

2. Description of the Related Art

Calendaring systems have formed the core component of personal information management software and firmware applications for decades. Initially, a mere calendar display, modern calendaring systems provide scheduling and alarm functions in addition to full integration with contact management, time entry, billing and project management applications. The typical calendaring application minimally provides a mechanism for scheduling an event to occur on a certain date at a certain time. Generally, the event can be associated with a textual description of the event. More advanced implementations also permit the association of the scheduled event with a particular contact, a particular project, or both. Furthermore, most calendar applications provide functionality for setting an alarm prior to the occurrence of the event, as well as archival features.

Several software products include support for Calendaring & Scheduling (C&S). Known C&S products include Lotus™ Notes™, Microsoft™ Outlook™, and web-based products like Yahoo!™ Calendar™. These products allow one to manage personal events including appointments and anniversaries. C&S products also typically allow one to manage shared events, referred to generally as meetings. Electronic C&S software allows a group of people to negotiate around the scheduling of a proposed event such as a meeting, with the goal of selecting a time that allows most of the group to attend.

Specifically, collaborators who participate in e-meetings often maintain a personal schedule managed by a scheduling system. Collaborators can schedule e-meetings within the personal schedule sua sponte, or the collaborators can schedule e-meetings responsive to the receipt of an invitation. An invitation typically contains data regarding the e-meeting such as a topic, list of invitees, and most importantly, a date, time and location for the e-meeting. Using this data, the invitee can be prompted either to accept or decline the invitation. Oftentimes, the acceptance or declination of an invitation can be accomplished with a single user action such as a mouse click.

Pending the acceptance or declination of a meeting, the proposed meeting will remain unprocessed. In some C&S systems, while a proposed meeting remains unprocessed, the proposed meeting will consume calendar space for the proposed meeting time in the invitee's calendar and no conflicting meetings will be permitted to be scheduled during the proposed meeting time. Consequently, great care must be taken to avoid unintentionally booking time in an invitee's calendar against the will of the invitee. In other C&S systems, until an invitee accepts a meeting invitation, the proposed meeting time will not be reserved and other proposed meetings can refer to the same proposed time.

Many C&S systems automatically process meeting invitations according to one or more rule sets and, additionally, many C&S systems warn end users prior to accepting a meeting invitation which conflicts with an already processed, existing meeting. Yet, due to the awkward state of an unprocessed meeting, an invitee may or may not accept a meeting invitation without the full benefit of knowledge of all unprocessed meetings referring to corresponding proposed meeting times. As such, often end users can accept one meeting invitation for a particular time slot only to discover moments later that another, more desirable meeting invitation requires the same time slot. Likewise, one proposing a meeting in a meeting invitation for a particular time slot in an invitee's calendar has no opportunity to know whether a competing, unprocessed meeting invitation refers to the same time slot.

### BRIEF SUMMARY OF THE INVENTION

Embodiments of the present invention address deficiencies of the art in respect to meeting time conflict management and resolution in a C&S system and provide a novel and non-obvious method, system and computer program product for event scheduling conflict management and resolution for unprocessed events in a collaborative computing environment. In one embodiment of the invention, a method of event scheduling conflict management and resolution for unprocessed events can be provided for a collaborative computing environment. The method can include proposing a new calendar event for a specified time slot not already scheduled for a processed calendar event, identifying an unprocessed, unscheduled, proposed event conflicting with the specified time slot, and prompting for conflict resolution of the conflict.

In one aspect of the embodiment, proposing a new calendar event for a specified time slot not already scheduled for a processed calendar event can include proposing to accept an invitation for a new calendar event for a specified time slot not already scheduled for a processed calendar event. In another aspect of the embodiment, proposing a new calendar event for a specified time slot not already scheduled for a processed calendar event can include proposing to forward to an invitee an invitation for a new calendar event for a specified time slot not already scheduled for a processed calendar event. In yet another aspect of the embodiment, proposing a new calendar event for a specified time slot not already scheduled for a processed calendar event can include viewing free/busy time to identify the specified time slot for the new calendar event not already scheduled for a processed calendar event.

Prompting for conflict resolution of the conflict can include listing the new calendar event with the specified time slot along with a plurality of unprocessed, unscheduled, proposed events, and selecting to reject all of the unprocessed, unscheduled, proposed events while concurrently scheduling the new calendar event. Prompting for conflict resolution of the conflict as an alternative can include listing the new calendar event with the specified time slot along with a plurality of unprocessed, unscheduled, proposed events and selecting to reject the new calendar event and all but one of the unprocessed, unscheduled, proposed events while concurrently scheduling a selected one of the unprocessed, unscheduled, proposed events.

In another embodiment of the invention, a C&S data processing system can be provided to include a data store of calendar events comprising processed, scheduled events for specified different time slots and unprocessed, unscheduled, proposed events associated with different time slots. The system also can include an event scheduler coupled to the data store of calendar events. Finally, the system can include unprocessed invitations processing logic coupled to the event scheduler. The logic can include program code enabled to identify any of the unprocessed, unscheduled, proposed events conflicting with a specified time slot for a proposed new calendar event. In one aspect of the embodiment, the unprocessed invitations processing logic further can be enabled to provide an invite processing user interface configured for event scheduling conflict management and resolution for unprocessed events in a collaborative computing environment. In another aspect of the embodiment, the unprocessed invitations processing logic further can be enabled to provide a free/busy time lookup user interface configured for event scheduling conflict management and resolution for unprocessed events in a collaborative computing environment.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1A is a pictorial illustration of an invite processing user interface configured for event scheduling conflict management and resolution for unprocessed events in a collaborative computing environment;

FIG. 1B is a pictorial illustration of a free/busy time lookup user interface configured for event scheduling conflict management and resolution for unprocessed events in a collaborative computing environment;

FIG. 2 is a schematic illustration of a C&S data processing system configured for invite processing user interface configured for event scheduling conflict management and resolution for unprocessed; and,

FIG. 3 is a flow chart illustrating a process for invite processing user interface configured for event scheduling conflict management and resolution for unprocessed events in a collaborative computing environment.

### DETAILED DESCRIPTION OF THE INVENTION

Embodiments of the present invention provide a method, system and computer program product for event scheduling conflict management and resolution for unprocessed events in a collaborative computing environment. In accordance with an embodiment of the present invention, unprocessed events can be considered for conflicts when scheduling a new event. In this regard, before accepting an invitation to a new event, unprocessed events can be considered for conflicts and potential conflicts can be brought to the attention of the end user. Likewise, before issuing an invitation for a new event, unprocessed events can be considered for conflicts and potential conflicts can be brought to the attention of the end user. In this way, not only will processed, scheduled events be considered for conflict management and resolution, but also proposed, but not yet scheduled events can be considered.

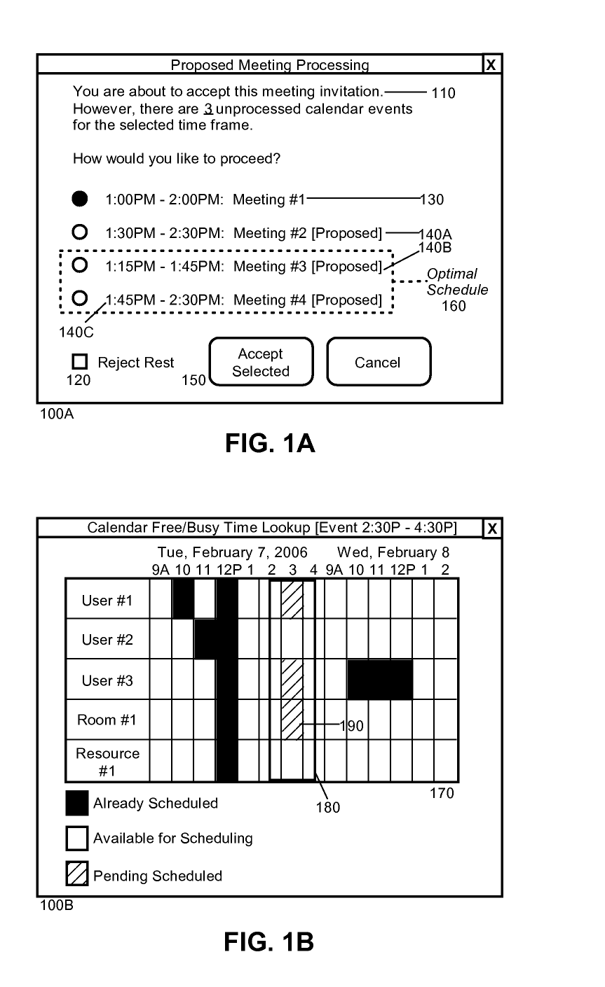

In illustration, FIG. 1A depicts an exemplary invite processing user interface configured for event scheduling conflict management and resolution for unprocessed events in a collaborative computing environment. As shown in FIG. 1A, a proposed meeting processing user interface 100A can be provided when receiving an invitation to a meeting in response to detecting a conflict with one or more yet to be scheduled, but already proposed (hence, unprocessed) events. The user interface 100A can include explanatory text 110 indicating that an event will be scheduled excepting for the presence of one or more unprocessed calendar events for the selected time frame.

The user interface 100A can provide a listing of both the subject event 130 as well as the unprocessed, previously proposed events 140A, 140B, 140C with overlapping time slots. The user interface 100A further can provided a scheduling control 150 for scheduling the selected event in the list. An additional rejection control 120 can be provided that, when selected, results in the rejection of the unselected events to the exclusion of the selected event in the list. Optionally, an optimal schedule indicator 160 can be provided indicating when multiple ones of the events in the list can be scheduled without conflict so as to minimize the number of conflicted events.

As additional illustration, FIG. 1B depicts a free/busy time lookup user interface configured for event scheduling conflict management and resolution for unprocessed events in a collaborative computing environment. The free/busy time user interface 100B can include a scheduling grid 170 reflecting scheduled and free time slots for different calendar users, locations and resources. Time slots that are scheduled already can have one visual appearance while time slots lacking any scheduled events can have a different visual appearance. Importantly, time slots proposed to be scheduled 190 for an unprocessed, yet to be scheduled event can have a third different appearance. In this regard, the time slot associated with a proposed invitation 180 can be indicated in the grid 170 and compared to the time slots proposed to be scheduled 190 to provide better guidance for the event schedule whether or not a conflict may exist.

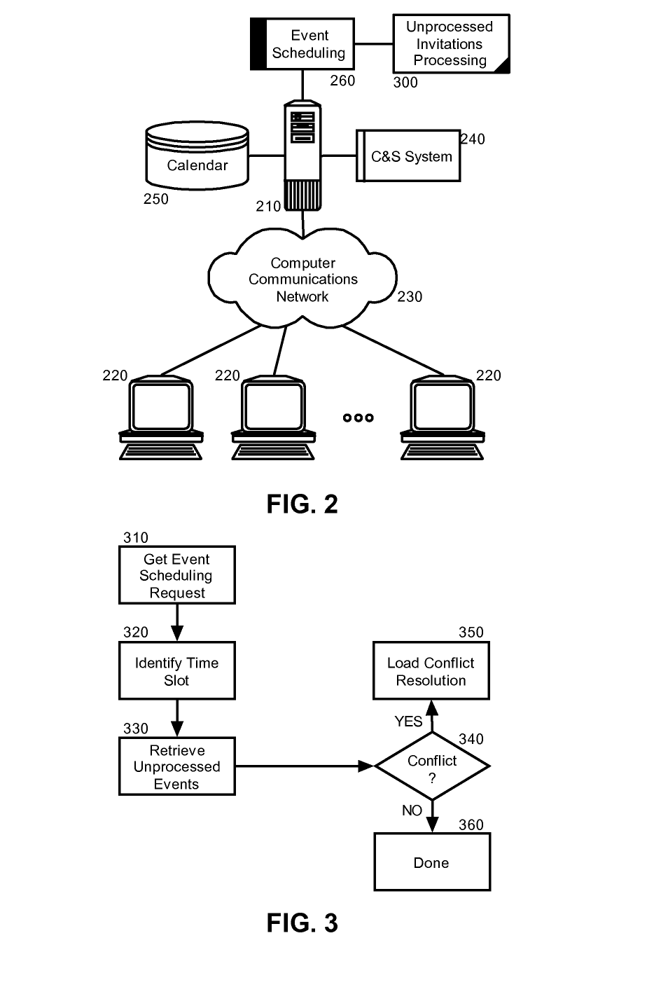

In further illustration, FIG. 2 is a schematic illustration of a C&S data processing system configured for invite processing user interface configured for event scheduling conflict management and resolution for unprocessed. The system can include a host computing platform 210 supporting the operation of a C&S system 240. A data store of calendar events 250 can be coupled to the host computing platform 210 and configured to store calendar events for the C&S system 240. The host computing platform 210 can be communicatively coupled to one or more collaborative computing clients 220 over computer communications network 230 so as to permit the collaborative computing clients 220 to access the C&S system concurrently.

An event scheduler 260 can be coupled to the C&S system 240 through host computing platform 210. The event scheduler 260 can be configured to process event invitation from different users of the C&S system by forwarding different invitations to different respective invitees. The event scheduler 260 further can be configured to schedule accepted ones of the invitations, while holding open unprocessed invitations not yet accepted or rejected. Notably, unprocessed invitations processing logic 300 can be coupled to the event scheduler 260. The logic 300 can include program code enabled to consider open, unprocessed invitations when managing an invitation for an event. In particular, a notification can be provided to an end user considering proposing or accepting an invitation for an event conflicting with an unprocessed, yet to be scheduled event.

In yet further illustration, FIG. 3 is a flow chart illustrating a process for invite processing user interface configured for event scheduling conflict management and resolution for unprocessed events in a collaborative computing environment. Beginning in block 310, an event scheduling request can be received. The request can include a request to propose an invitation for a meeting, a request to view free/busy time for one or more users, locations or resources of the collaborative computing environment, or a request to accept an invitation for a meeting. In block 320, a time slot can be identified for the request and in block 330, one or more unprocessed, yet to be accepted or rejected events can be retrieved and compared to the time slot. In decision block 340, if a conflict does not exist for the time slot the process can end in block 360. Otherwise, conflict resolution in block 350 can resolve the conflict. Conflict resolution can include merely notifying the end user of the conflict, rejecting the unprocessed events or the request itself, or accepting the proposed event irrespective of the conflict.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A method of event scheduling conflict management and resolution for unprocessed events in a collaborative computing environment, the method comprising:
proposing a new calendar event for a specified time slot not already scheduled for a processed calendar event;
identifying an unprocessed, unscheduled, proposed event conflicting with the specified time slot; and,
prompting for conflict resolution of the conflict.

2. The method of claim of claim 1, wherein proposing a new calendar event for a specified time slot not already scheduled for a processed calendar event, comprises proposing to accept an invitation for a new calendar event for a specified time slot not already scheduled for a processed calendar event.

3. The method of claim of claim 1, wherein proposing a new calendar event for a specified time slot not already scheduled for a processed calendar event, comprises proposing to forward to an invitee an invitation for a new calendar event for a specified time slot not already scheduled for a processed calendar event.

4. The method of claim of claim 1, wherein proposing a new calendar event for a specified time slot not already scheduled for a processed calendar event, comprises viewing free/busy time to identify the specified time slot for the new calendar event not already scheduled for a processed calendar event.

5. The method of claim 1, wherein prompting for conflict resolution of the conflict comprises:
listing the new calendar event with the specified time slot along with a plurality of unprocessed, unscheduled, proposed events; and,
selecting to reject all of the unprocessed, unscheduled, proposed events while concurrently scheduling the new calendar event.

6. The method of claim 1, wherein prompting for conflict resolution of the conflict comprises:
listing the new calendar event with the specified time slot along with a plurality of unprocessed, unscheduled, proposed events; and,
selecting to reject the new calendar event and all but one of the unprocessed, unscheduled, proposed events while concurrently scheduling a selected one of the unprocessed, unscheduled, proposed events.

7. The method of claim 1, wherein prompting for conflict resolution of the conflict comprises:
listing the new calendar event with the specified time slot along with a plurality of unprocessed, unscheduled, proposed events;
determining whether multiple ones of the unprocessed, unscheduled, proposed events can be scheduled without conflict in lieu of the new calendar event; and,
identifying the determined multiple ones of the unprocessed, unscheduled, proposed events as an optimal schedule.

8. A calendaring and scheduling (C&S) data processing system comprising:
a data store of calendar events comprising processed, scheduled events for specified different time slots and unprocessed, unscheduled, proposed events associated with different time slots;
an event scheduler coupled to the data store of calendar events; and,
unprocessed invitations processing logic coupled to the event scheduler, the logic comprising program code enabled to identify any of the unprocessed, unscheduled, proposed events conflicting with a specified time slot for a proposed new calendar event.

9. The system of claim 8, wherein the unprocessed invitations processing logic further is enabled to provide an invite processing user interface configured for event scheduling conflict management and resolution for unprocessed events in a collaborative computing environment.

10. The system of claim 8, wherein the unprocessed invitations processing logic further is enabled to provide a free/busy time lookup user interface configured for event scheduling conflict management and resolution for unprocessed events in a collaborative computing environment.

11. A computer program product comprising a computer usable medium embodying computer usable program code for event scheduling conflict management and resolution for unprocessed events in a collaborative computing environment, the computer program product comprising:
computer usable program code for proposing a new calendar event for a specified time slot not already scheduled for a processed calendar event;
computer usable program code for identifying an unprocessed, unscheduled, proposed event conflicting with the specified time slot; and,
computer usable program code for prompting for conflict resolution of the conflict.

12. The computer program product of claim 11, wherein the computer usable program code for proposing a new calendar event for a specified time slot not already scheduled for a processed calendar event, comprises computer usable program code for proposing to accept an invitation for a new calendar event for a specified time slot not already scheduled for a processed calendar event.

13. The computer program product of claim 11, wherein the computer usable program code for proposing a new calendar event for a specified time slot not already scheduled for a processed calendar event, comprises computer usable program code for proposing to forward to an invitee an invitation for a new calendar event for a specified time slot not already scheduled for a processed calendar event.

14. The computer program product of claim 11, wherein the computer usable program code for proposing a new calendar event for a specified time slot not already scheduled for a processed calendar event, comprises computer usable program code for viewing free/busy time to identify the specified time slot for the new calendar event not already scheduled for a processed calendar event.

15. The computer program product of claim 11, wherein the computer usable program code for prompting for conflict resolution of the conflict comprises:
computer usable program code for listing the new calendar event with the specified time slot along with a plurality of unprocessed, unscheduled, proposed events; and,
computer usable program code for selecting to reject all of the unprocessed, unscheduled, proposed events while concurrently scheduling the new calendar event.

16. The computer program product of claim 11, wherein the computer usable program code for prompting for conflict resolution of the conflict comprises:
computer usable program code for listing the new calendar event with the specified time slot along with a plurality of unprocessed, unscheduled, proposed events; and,
computer usable program code for selecting to reject the new calendar event and all but one of the unprocessed, unscheduled, proposed events while concurrently scheduling a selected one of the unprocessed, unscheduled, proposed events.

17. The computer program product of claim 11, wherein the computer usable program code for prompting for conflict resolution of the conflict comprises:
computer usable program code for listing the new calendar event with the specified time slot along with a plurality of unprocessed, unscheduled, proposed events;
computer usable program code for determining whether multiple ones of the unprocessed, unscheduled, proposed events can be scheduled without conflict in lieu of the new calendar event; and,
computer usable program code for identifying the determined multiple ones of the unprocessed, unscheduled, proposed events as an optimal schedule.
